(19) United States
(12) Patent Application Publication
(10) Pub. No.: US 2017/0143002 A1
(43) Pub. Date: May 25, 2017

(54) EQUINE FEED PRODUCTS AND METHODS OF PRODUCING AND FEEDING SAME

(71) Applicant: PURINA ANIMAL NUTRITION LLC, Shoreview, MN (US)

(72) Inventors: Kent Lanter, Waterloo, IL (US); Mary Beth Gordon, Wappinger Falls, NY (US)

(21) Appl. No.: 14/952,628

(22) Filed: Nov. 25, 2015

(51) Int. Cl. A23K 1/18; A23K 1/00; A23K 1/16

(52) U.S. Cl. CPC A23K 1/1806; A23K 1/164; A23K 1/003; A23K 1/004

(57) ABSTRACT

High-fat equine feed products with increased palatability may be produced by combining equine feed components into a mixture having an initial percentage of fat, extruding the mixture using an extruder, drying the mixture, vacuum-coating additional fat into the mixture to form the feed product having a resulting level of low fines. Feeding a high-fat feed product to an equine animal involves obtaining a high-fat feed with a smooth, fat-coated exterior with low fines, which includes at least about 25 wt % fat, combining the high-fat feed with a base feed, and feeding the high-fat feed combined with the base feed to an equine animal. In response to the high-fat feed having the smooth, fat-coated exterior and having low fines, the equine animal increases consumption of the high-fat feed.

### TECHNICAL FIELD

Implementations relate to equine feed products and methods of producing and feeding such equine feed products. More particularly, implementations provide methods of incorporating high fat levels into extruded equine feed products that result in high-fat feed products with low fines as well as enhanced palatability and intake by the equine animal.

### BACKGROUND

Equine animals derive their nutrition through a variety of feed sources. Some equine animals rely on forages including hay, pasture grass, and other plant materials. Commercial feeds also offer special varieties formulated for different animals and specific purposes. These commercial assortments typically take the form of textured feeds, pellets, or extruded nuggets, each with varying appearance and consistency. Diet formulations designed to foster equine weight gain may incorporate additional sources of fat directly into the feed nuggets. Consuming diets rich in fat enable equine animals to gain weight safely, improve performance levels without fatiguing, increase heat tolerance, avoid injury, reduce the likelihood of colic and laminitis, improve skin and coat health, and can help lactating equines breed more quickly. Fat is easily metabolized by equine animals and therefore provides a potent source of energy, however, high-fat feed is typically much less palatable to equine animals than similar feeds with less fat. In light of these benefits and because weight gain can be difficult to achieve in equine animals, techniques capable of increasing calorie consumption in equine animals offer tremendous value.

### SUMMARY

Implementations provide methods of producing high-fat equine feed products having increased palatability. Additional implementations provide methods of feeding a high-fat equine feed product to equine animals. The high-fat equine feed products have low levels of or are substantially free of fines, at about 3 wt % or lower of the feed product, preferably at 1 wt % or lower of the feed product.

In one implementation, a method of producing a high-fat equine feed product having increased palatability involves combining equine feed components into a mixture that includes an initial percentage of fat, adding the mixture to an extruder and extruding the feed. The method then proceeds with drying the feed using a dryer, and vacuum-coating an additional fat into the dried, extruded mixture, thereby producing the feed product. The feed product includes about 25 to about 40 wt % fat of the feed product. By producing a high-fat equine feed product according to this method, the feed product includes low levels of fines.

In various implementations and alternatives, the initial percentage of fat included in the mixture is about 5 to 13 percent by weight of the feed product.

In additional implementations and alternatives, the high-fat equine feed product includes about 25 to about 33 percent fat by weight of the feed product.

In addition or alternatively, the moisture level of the dried feed prior to vacuum coating is about 1 to 4 percent by weight.

In additional implementations and alternatives, the initial percentage of fat includes endogenous fat, the added fat may include palm oil, and/or the mixture is free of added fat prior to the step of vacuum-coating the additional fat.

In additional implementations and alternatives, the step of vacuum-coating comprises applying a vacuum and releasing the vacuum over a period of about 20 to about 40 seconds

In additional implementations and alternatives, the vacuum reaches a pressure of about 200 to 250 mbar.

In additional implementations and alternatives, steam is added to the extruder. The steam may be added at an amount of up to about 0.1 to about 6.0 percent by weight of the feed mixture, and/or the extruded feed is dried for about 1 to 30 minutes at a temperature of about 200 to 600° F.

In various implementations and alternatives, the method further involves cooling the vacuum-infused feed.

In another implementation, a method of feeding the high-fat feed product to an equine animal involves obtaining the high-fat feed product that includes at least about 25 percent by weight of fat and includes a smooth, fat-coated exterior and has low levels of fines, combining the high-fat feed product with a base feed, and feeding the high-fat feed product combined with the base feed to the equine animal. In response to the high-fat feed product, the equine animal increases consumption of the high-fat feed product.

In additional implementations and alternatives, the step of feeding the high-fat feed product to the equine animal further comprises feeding forage to the animal.

In additional implementations and alternatives, the equine animal improves performance in response to ingesting the high-fat feed product. In addition or alternatively, the equine animal is a high performance animal.

In additional implementations and alternatives, the equine animal consumes about 1.5 to 4.0 pounds of the high-fat feed product per day, or about 3.0 to 4.0 pounds of the high-fat feed product per day.

### BRIEF DESCRIPTION OF THE DRAWINGS

FIG. 1 is a bar chart illustrating daily intake of an equine feed product of the present disclosure relative to a control feed.

### DETAILED DESCRIPTION

Weight gain provides a number of advantages to equine animals. The process of gaining weight requires the consumption of more calories than are expended over time. For some hard working animals, simply maintaining a constant weight may also require an increased consumption of calories. Equine dieting regimes may therefore involve increasing the number of calories consumed, decreasing the number of calories exhausted, or both. Because the equine animals in need of weight gain or weight maintenance are often performance animals, suppressing energy expenditure is not a viable option for accomplishing this goal. This places the burden of weight gain or weight maintenance on an ability to increase caloric intake. Because equine animals can only consume a limited volume of feed per day, boosting the caloric density of their feed provides a practical means for increasing calories ingested. Increasing feed density requires meticulous attention to the specific sources of additional calories. While weight gain or weight maintenance might be the ultimate objective, it must be achieved without sacrificing the overall condition of the equine animal. For example, starch provides a significant source of calories, but high starch levels can disrupt the pH balance and microbial activity of the equine digestive system. In addition, high-calorie feed must remain appetizing to the equine animal to ensure consumption. Fat may supply the extra calories desired, but fat is a negative palatant to equine animals, which exhibit high sensitivity to even slight increases in the fat content of their feed. Traditional methods for increasing fat content involve mixing vegetable oil with feed, but the amount of oil needed to provide a substantial increase in calories creates distasteful, messy feed lacking important nutrients that is often refused by the equine animal.

Applicant's discovery of methods for producing high-fat feed products that remain palatable to equine animals is the surprising result of experimentation with the manufacturing processes used to produce the feed. Applicant understood that increasing the fat content of the equine animal's diet through the use of supplemental high-fat feeds could enhance equine weight gain, but the animal's natural aversion to such high-fat feeds presents problems for the animal consuming the feed, which can result in unpredictable intake. Accordingly, Applicant endeavored to develop new high-fat feed products that are nonetheless palatable and thus consumed by equine animals. Provided herein are high-fat equine feed products, methods of producing such feed products, and methods of feeding such feed products in order to result in increased palatability, increased consumption and/or improved performance in the equine animals. For instance, production methods use a high-fat formula but alter the timing and techniques used to add additional fat compared to prior approaches, resulting in equine feed products with low fines and increased palatability. As provided herein, the additional fat is not added to the meal, but rather is infused into the feed product using vacuum pressure after extrusion and drying. Not only does this method improve palatability, but it produces equine feed products with a distinct appearance that includes low levels of fines. Fines are generally understood to be small particles of the feed product that break apart from larger feed particles or nuggets and may be produced during feed production and/or following production, such as during packaging and handling. The fines become interspersed within the feed product and can adhere to the feed product, giving a dusty or grainy appearance and texture to the product. The lack of fines and uniform size provide improvements over prior approaches used to produce high fat equine feed. Feeding equine animals the feed products results in increased uptake beneficial for weight gain and enhanced performance.

Equine Animal Feed Products

Equine animal feed products may be feed nuggets or pellets comprised of a porous matrix with fat permeated in the pores and defining a coating over at least a portion of the exterior of the matrix. The matrix may be composed of starch, fat, fiber, protein, vitamins, nutrient and optional flavorants. The feed products may contain high levels of fat for consumption by the equine animals and may therefore be referred to as high-fat feeds.

Starch sources in the porous matrix of the feed products may include, but are not limited to: grains such as rice, stabilized rice bran, oats, barley, wheat products such as wheat middlings, and corn products such as ground corn, corn grain, cracked corn, and corn germ meal. Starch may be present in the feed at about 10 to 25 percent, about 8 to 20 percent, about 8 to 15 percent, about 12 to 16 percent, or about 13 to 15 percent by weight of the feed.

Fat sources in the porous matrix of the feed products, that permeate the matrix and that coat the matrix may include, but are not limited to: various amounts of plant-derived oils such as vegetable oil, soy oil, corn oil, canola oil, palm oil, and/or flaxseed oil and whole ground flaxseed. In the porous matrix, fat sources may be inherent in certain feed components such as beans (e.g., soybeans) and flax, and may additionally be in the form of added fats, such as palm oil and stearin. Such added fats may contain palmitic acid, stearic acid, lauric acid, myristic acid, coco butter and any hydrogenated fat or oil. The proportion of fat within the porous matrix may be about 1 to 15 percent, about 8 to 12 percent, or about 9 to 11 percent by weight of the feed product. The proportion of added fat permeating and/or coating the porous matrix of the feed product, such as in the form of palm oil, stearin, and/or stearic acid, comprises about 15 to 25 percent, about 17 to 23 percent, or about 19 to 21 percent by weight of the feed product. The total fat content present in the feed product may be about 25 to 40 percent, about 25 to 35 percent, about 30 to 35 percent, or about 28 to 33 percent by weight of the feed.

Protein products in the porous matrix of the feed products may include, but are not limited to: beans such as soybean products including soybean meal and dehulled soybean meal. Protein may be present in the high-fat feed at about 10 to 22 percent, about 12 to 20 percent, about 12 to 16 percent, or about 13 to 15 percent by weight of the feed.

Fiber sources in the porous matrix of the feed products may include, but are not limited to: various amounts of wheat products such as wheat middlings, rice bran, flaxseed, and soybean hulls, rice hulls and oat hulls. Fiber may be present in the feed at about 2 to 8 percent, about 2 to 6 percent, or about 3 to 6 percent by weight of the feed.

Vitamins, micronutrients, and macronutrients in the feed products may include, but are not limited to: various amounts of calcium carbonate, monocalcium phosphate, dicalcium phosphate, choline chloride, iron oxide, DL-alpha tocopheryl acetate, cholecalciferol, calcium pantothenate, vitamin B12 supplement, riboflavin, vitamin A acetate, zinc oxide, copper, copper sulfate, calcium iodate, nicotinic acid, DL-methionine, L-lysine, magnesium oxide, natural mixed tocopherols, ascorbic acid, cobalt carbonate, lecithin, ferrous carbonate, manganous oxide, and sodium selenite. Vitamins, micronutrients, and macronutrients may be present in the high-fat feed at about 2 to 9 percent, about 3 to 7 percent, or about 4 to 6 percent by weight of the feed.

Optional flavorants in the feed products may include, but are not limited to: various amounts of cane molasses, salt, citric acid, and rosemary extract. Flavorants may be present in the high-fat feed at about 1 to 7 percent, about 2 to 5 percent, or about 2 to 4 percent by weight of the feed.

The foregoing nutrient components may fall within multiple nutrient categories. For example, wheat middlings constitute a source of both protein and fiber.

By providing nutrients derived from a variety of plant sources, the foregoing feed components provide the nutritional diversity usually obtained only through natural equine foraging behavior. The embodiments are not limited to these nutritional components, however, and may contain a large variety of other nutrient combinations in various amounts. The feed components listed here that are not critical to the proper formation of high-fat feed products for equine animals can be substituted or omitted. In some implementations the high-fat feed product may be free of ionophores (an antibiotic commonly found in cattle feed that may be poisonous to horses), urea, ammonium sulfate, diammonium phosphate, or other non-proteinaceous sources of nitrogen.

The high-fat equine feed products exhibit several noticeable differences from prior high-fat products. For example, the disclosed high-fat feed products are substantially free of fines, which contributes to their smooth surface texture. The level of fines present in the feed product may be quantified by sieving the feed product through a Tyler mesh screen comprised of 6 openings per linear inch, each opening approximately 3.36 mm wide. In one embodiment, the high-fat feed products may have low fines, which may correspond to about 0.01 to about 3 wt % of the feed product. The level of fines present in other implementations may be about 0.01 to 3 percent, about 0.01 to 2 percent, or about 0.01 to 1 percent of the feed product. Similarly formulated feed products not produced via the methods disclosed herein may contain a level of fines of about 4.0 percent. In addition, the feed product is durable, which prevents the recreation of fines. That is, during packaging and handling of the feed, fines do not break off from the feed product. This durable product also includes a smooth texture which may be attributed to the fat that coats the exterior and which may contribute to the prevention of new fines. Fat additionally seeps through the pores of the matrix, permeating throughout the interior of the matrix. The high-fat feed products are also more uniformly sized and more durable than similarly composed products produced via dissimilar methods.

Methods of Manufacturing Equine Animal Feed Products

Production of the feed product involves combining the feed components that will eventually form the porous matrix. The feed components may be mixed until a relatively homogenous mixture of dry feed meal is formed. In one embodiment, the initial mixture contains approximately 88 to 90 percent grains and beans, about 7 to 9 percent vitamins and minerals, and about 2 to 4 percent sugar sources by dry weight of the initial feed mixture. The grains and beans may include, for instance, corn products, soybean products, wheat products, flaxseed products, and/or various other forms of grain. The vitamins and minerals may include, for instance, a mixture of calcium, phosphorus, sodium, copper, selenium, zinc, vitamin A, and/or vitamin E. The sugar content may include, for instance, molasses and/or various other forms of sugar. In one embodiment, the moisture level of the initial mixture may be about 5 to 25 percent, about 8 to 15 percent, or about 10 to 13 percent by weight.

The initial mixture may contain fat at a level of about 1 to about 18 percent, about 10 to about 15 percent, or about 11 to about 14 percent by weight of the extruded product prior to vacuum infusion of fat (described herein). This amount of fat may contribute a fraction of the total fat in the final, vacuum-infused product, which may contain about 35 weight percent fat. For instance, of the final weight of the feed product, the fat in the initial mixture may contribute fat at a level of about 1 to about 15 percent, about 8 to about 12 percent, or about 9 to about 11 percent by weight. In some embodiments, this fat is endogenous to the original components and no additional fat is necessary to attain the initial percentage of fat desired. In other embodiments, the fat is not entirely inherent in the initial ingredients and may be added separately to the mixture in the form of palm oil, vegetable oil, flaxseed oil, stearin, stearic acid, corn oil, canola oil, and/or various other sources of oil.

After mixing, an extrusion process may be used to form the mixture into the feed product, e.g., nugget. The extruder used for product formation may be a standard extruder, with a hopper for receiving the feed components or mixture thereof. The hopper channels the mixture into a conditioner for preparation, where water and steam may be added to the feed mixture, which may be heated to about 150° F. to 260° F. After passing through the conditioner, the feed mixture in the form of meal is channeled into the extruder, where it undergoes heat and pressure treatment. Once the feed is sufficiently mixed and reaches a temperature of about 212° F. to 300° F. within the extruder barrel, it is forced from the extruder under high pressure by a rotating screw. The screw exerts a high compacting pressure on the mixture, which may range from about 20 to about 150 psig (pounds per square inch, gauge). The rotating screw pushes the compacted feed mixture through a die with a defined opening, shaping the feed. A single-screw or twin-screw extruder may be used at this step to compact and drive the meal through the extruder barrel. Standard cutting techniques may then be used to slice the feed at predetermined lengths as it emerges from the die, which gives the feed product its final shape.

Supplemental lubrication in the form of steam may be necessary to compensate for a reduced amount of oil in the original feed mixture. Specifically, the rate and/or amount of steam injection in the extruder barrel is intensified to lower the viscosity of the feed mixture, avoid overloading the extruder motor, and reduce wear on the rotating screw that can be exacerbated in the absence of oil. In some embodiments, an amount of steam may be injected into the extruder from about 0.1 to about 6.0 percent by weight of the feed mixture or about or at least about 0.5 percent by weight of the feed mixture. Known valving techniques may be used to modify the rate and amount of steam added to the extruder. In some embodiments, the number of steam injectors will be varied to avoid surge. The steam also adds heat to the compacted ingredients, which in conjunction with the heat generated by the mechanical work occurring in the extruder barrel, raises the mixture temperature to an excess of about 212° F. The added steam, along with the water added to the extruder conditioner and barrel, may raise the moisture content of the mash to about 20 to 35 percent, or about 25 to 30 percent by weight.

After the product exits the extruder, it is dried in a dryer to stabilize and harden the product. The retention time and temperature used to dry the product may vary. In some embodiments, the products are dried for about 15 to about 30 minutes at about 200 to about 300° F. In another embodiment, the products are dried for about 1 to 3 minutes at about 550° F. to 650° F. Alternative embodiments may require a drying period of about 1 to about 30 minutes at a temperature of about 650° F. to about 200° F., with the drying temperature decreasing with increasing drying times. The drying conditions reduce the moisture level of the product to a low level, which may range from about 1 to about 8 percent, about 1 to 6 percent, about 1 to 4 percent or about 2 to 3 percent. At this stage, the fully expanded and dried product forms a porous matrix containing pores and internal air pockets. The porous texture of the product facilitates the infusion of an additional fat source.

After drying, the product may be transferred to a vacuum coater for infusion of the additional fat. A standard vacuum coater may be used for this step. To prevent the added fat from solidifying before it penetrates the nuggets, the dried nuggets may not be allowed to cool well below their drying temperature before the vacuum coating step. For instance, the nuggets, just prior to vacuum coating, may be at a temperature of about 100 to about 200° F. or at a temperature above the melting point of the added fat. In addition or alternatively, the dried nuggets may be heated to these temperatures just prior to vacuum coating to ensure that the temperature of the nuggets exceeds the melting point of the added fat. The vacuum generates a negative pressure in the vacuum chamber ranging from about 200 to about 520 mbar, from about 200 to about 250 mbar, or from about 500 to about 520 mbar. The additional fat source may be added to the vacuum, coating the product. In some implementations, the fat may be heated to approximately 190° F., and such heating may take place within or external to the vacuum environment. While under vacuum conditions, in addition to infusing fats, some moisture within the feed product may be removed.

The added fat may comprise about 15 to 25 percent, about 17 to 23 percent, or about 19 to 21 percent by weight of the finished feed product. In a particular embodiment, the additional fat may comprise at least about 17 percent by weight of the feed product to reach a targeted fat content of about 30 percent by weight in the finished product. Upon addition of this fat, the total fat content may comprise about 25 to 40 percent, about 25 to 35 percent, about 30 to 35 percent, or about 28 to 33 percent by weight of the feed product. In some embodiments, the additional fat source comprises palm oil, vegetable oil, or various other sources of oil described herein.

After maintaining a pressurized vacuum for a time sufficient to achieve an even coating of fat on the high-fat feed product, the vacuum is slowly released. Releasing the vacuum pressure infuses the added fat into the pores of the product, allowing the fat to permeate throughout the inner matrix of the product. To achieve adequate infusion of the additional fat, the duration of vacuum release is optimized. In some embodiments, the vacuum may be released over a period of about 20 to 40 seconds, about 20 to 35 seconds, about 22 to 32 seconds, or about 26 to 30 seconds.

Following release of the vacuum, the feed product is cooled to allow the recently-added fat to solidify and the feed product to harden. The feed may be cooled by passing ambient or chilled air through the feed. The temperature of the air used to cool the feed may be less than about 80° F., or at about ambient temperatures, e.g., 65° F. to about 80° F.

The resulting feed product includes a smooth surface with low levels of fines that is durable and resists the generation of new fines during handling. The noticeable reduction of fines at the surface of the products represents a sharp contrast from high-fat products produced without vacuum coating the additional fat, which exhibit a rough surface texture with many fines. The products are also more uniformly sized than products comprised of similar ingredients that are not subjected to vacuum infusion. These material and visual differences in the products were unexpected and may contribute to their increased palatability as described herein. Increased palatability may also be attributed to potentially improved odor, taste, texture, color, and/or any other characteristic of the disclosed high-fat product that may be more agreeable to the equine animal.

Methods of Using Equine Animal Feed Products

Methods of using the feed products involve feeding the disclosed high-fat feed products to an equine animal. Methods may involve obtaining the feed product, such as in the form of a nugget, which includes a fat content of at least about 25 percent by weight. As produced by the disclosed methods, the products have a smooth, fat-coated exterior that have low levels of fines.

In some embodiments, the high-fat feed product is overlaid on top of a base feed, providing a top dress. The high-fat feed product may also be intermixed with the base feed. The base feed may comprise any feed typically fed to equine animals. The base feed may comprise about 14 percent crude protein, about 6 percent crude fat, about 12 percent fiber, moderate amounts of starch and sugar, and trace amounts of various vitamins and minerals. The high-fat products may serve as a supplement to the equine diet. Accordingly, the high-fat feed may be referred to as supplemental feed.

The high-fat feed product comprises a portion of the daily equine diet, in which equine animals typically consume from about 2 to 3 percent of their body weight in dry matter, which includes both forage and grain products. For optimal digestive health, equine animals consume at least about 1.2 percent of their body weight in forage every day. Sources of forage may include long-stem hay, pasture, hay cubes, hay pellets, and complete feeds comprising an amount of forage.

The amount of high-fat feed product fed to and available for consumption by the equine animal is based on numerous factors including the animal's size, age, temperament, health status, forage quality, climate, and activity level. The amount of weight and the time available to gain it also influence the amount of high-fat feed fed to the equine animal. Furthermore, the manner in which the high-fat feed product is fed to and available for consumption impacts the amount of high-fat product consumed. For instance, it has been discovered that the equine animal consumes a greater amount of high-fat feed product if it is provided as a top dress rather than intermixed with the base feed. Accordingly, feed rates may vary among animals. For example, if the equine animal consumes about 12 total pounds of feed per day intermixed with the high-fat feed product disclosed herein, the total intake of high-fat feed may be about 0.75 pounds per day, which corresponds to a total daily fat intake of about 0.9 pounds (0.75 lbs. high-fat feed at 30% fat (0.75(0.30)=0.225 lbs. fat)→12 total lbs. feed−0.75 lbs. high-fat feed=11.25 lbs. base feed at 6% fat (11.25(0.06)=0.675 lbs. fat)→0.675+0.225=0.9 lbs. total daily fat.). Alternatively, if the high-fat product is provided as a top dress, the high-fat feed intake may range from about 1 to 2 pounds daily, corresponding to about 0.3 to about 0.6 pounds of fat derived solely from the high-fat product, and about 1 to about 1.2 pounds of total fat overall. In other embodiments, the equine animals may consume about 0.5 to about 4 pounds, about 0.5 to about 2 pounds, about 2 to about 3 pounds, or about 3 to about 4 pounds of the high-fat feed product daily, corresponding to about 0.15 to about 1.2 pounds of fat derived from the high-fat feed product. In combination with a base feed, consumption of the high-fat feed may result in an overall increase in daily fat intake of about 15 to 230 percent, 15 to 100 percent, 15 to 50 percent, or 15 to 30 percent.

It has been discovered that the equine animal, when fed the high-fat product in the manner described, exhibits increased consumption of the high-fat products of the present disclosure compared to other high-fat products with similar compositions. More specifically, by providing a majority of the fat in the high-fat feed product as a vacuum-infused added fat, which results in fat permeating the matrix and forming a coating on the exterior of the feed product resulting in low levels of fines, leads to a marked increase in consumption of the feed product compared to similarly formulated feed products. Additionally, it has been discovered that by providing the high-fat product as a top dress in the manner described, the equine animal consumes more of the base feed as well, resulting in an increase in total feed consumption. In response to the increased consumption, enhanced performance of the animals may result over time.

Performance equine animals may include lactating animals, animals preparing for sale, or animals trained for racing or competitive showing.

### Example 1

High-Fat Feed Nugget Palatability Test

This study was conducted to assess palatability of the high-fat equine feed product of the present disclosure, in nugget form, when fed to equine animals using the disclosed methods. By offering each horse in the study two separate varieties of feed and measuring daily intake over the duration of the study, it was determined which variety the horses preferred.

Materials and Methods

The palatability trial was conducted over five consecutive days. Ten horses participated in the trial, with each horse fed in separate palatability stalls. Each horse was simultaneously offered two varieties of feed in separate feed buckets. The treatment diet contained high-fat nuggets produced using the methods disclosed herein. The control diet contained an equal amount of nuggets with matching fat content and similar ingredients, but produced using a different process that does not incorporate the vacuum coating step of this disclosure. The control feed included high levels of fines, greater than at least about 3 percent. Both feed options were served as a top dress, overlaid above a layer of base feed. For each feeding session, a one pound top dress of high-fat feed was overlaid above 2 pounds of base feed. The same base feed was used for both feed options.

The horses were each allowed to eat for ten minutes, after which they were promptly removed from the feeding stalls. The remaining feed was weighed automatically using an electronic scale placed beneath the feed buckets, and the numbers were automatically downloaded into a software system. The horses were fed twice daily. The location of the feed was alternated from the left side of the horse to the right side with each feeding session to avoid directional feeding bias, as some horses prefer to feed on their right and others their left.

Results and Conclusions

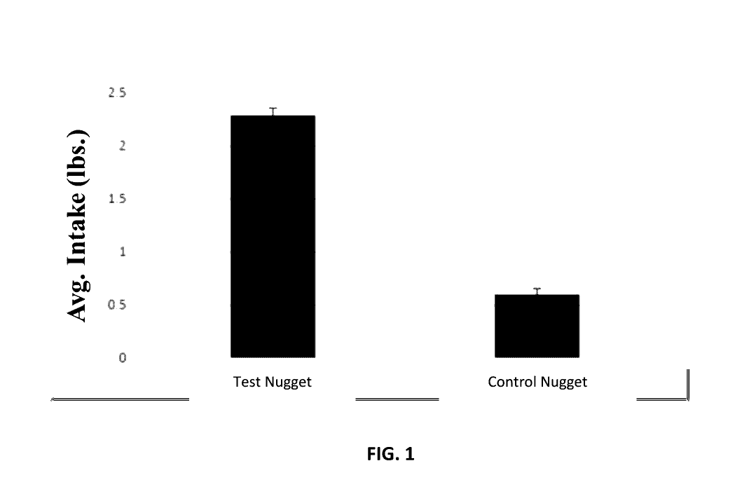

The high-fat nuggets of the present disclosure were preferred over the control nugget at a ratio of 4:1, with a statistical P-value of less than 0.0001. The vacuum-coated, high-fat nuggets therefore exhibited a statistically significant increase in palatability over a feed nugget of similar composition but produced differently. The results of the study are depicted in FIG. 1, which is a bar chart of the average intake per feeding for the treatment nuggets produced via the disclosed method versus the average intake of the control nuggets produced via traditional methods. As shown, the average intake per feeding of the treatment nuggets was approximately 2.29 pounds. The average intake of the control nuggets was a mere 0.59 pounds.

This study demonstrates that the palatability of high-fat feed products can be substantially improved by altering the conditions used to manufacture it. More specifically, adding the majority of the total fat content via vacuum infusion after extrusion and drying leads to a marked increase in consumption compared to a similarly formulated feed nugget. It is believed that the enhanced palatability is the result of the observable differences of the feed nuggets and their production methods. For example, the nuggets have a smooth surface texture and noticeably low levels of fines. The nuggets are also more uniformly sized than control nuggets of similar composition. These differences in appearance and texture could be contributing to the appeal of this new and improved equine feed.

### Example 2

Multiple batches of the high-fat nuggets disclosed herein were produced under a spectrum of conditions. First, dry feed meal comprised of the components disclosed herein was added to an extruder at a feed rate ranging from about 190 to 350 pounds per minute. The meal was then prepared in a conditioner according to the methods disclosed herein, which raised the temperature of the feed meal to about 154 to 165° F. The demand for steam rose with increased feed rates, as the number of required steam injectors ranged from 1 up to 3. The injectors were used to inject steam into the feed meal, which raised the moisture level of the feed to about 12 to 15 percent by weight. Nascent feed meal exited the extruder through either a 152-hole or 228-hole die and was cut at predefined lengths by either 8 knife blades operating at 1400 rpm or 16 knife blades operating from 400 rpm to 600 rpm.

Following extrusion but before drying and vacuum-coating, the feed nuggets showed good expansion and proper cell structure, with a density ranging from about 35 to 38 pounds per bushel.

The feed nuggets were dried using an Extru-Tech conventional low temperature dryer for 16 to 20 minutes at 240 to 280° F. This retention time and temperature adequately dried the feed nuggets.

After drying, the nuggets were transferred to a vacuum coater for infusion of the additional fat source. For several of the batches of high-fat nuggets produced, a total supply of about 700 pounds of palm oil was used, from which the oil was pumped into the vacuum coater. The vacuum maintained a pressure of 220 mbar until the pressure was slowly released to infuse the fat within the nuggets. The vacuum-coated fat comprised about 19 percent by weight of the high-fat nuggets.

The final density of the high-fat nuggets after drying and vacuum coating was about 48 pounds per bushel. The high-fat nuggets cooled normally after coating, and formed very hard nuggets with low levels of fines.

The first three trials produced high-fat nuggets comprising about 27, 22, and 29.2 percent by weight of fat, respectively, and about 6.2, 6.5, and 5.75 percent by weight of moisture. The next two batches, produced using an alternative palm oil variety, generated nuggets comprising about 25.7 percent and 36.9 percent by weight of fat, respectively, and 7.15 percent and 5.8 percent by weight of moisture. Another trial produced high-fat nuggets with only 3.1 percent moisture by weight.

The total fat target level for the first five trial batches was 30 percent by weight of the feed nuggets. Notably, even the high-fat nuggets comprised of 36.9 percent by weight of total fat showed the desired texture and consistency.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of producing a high-fat equine feed product having increased palatability, the method comprising:
combining equine feed components into a mixture, wherein the mixture includes an initial percentage of fat;
adding the mixture to an extruder;
extruding the mixture from the extruder;
drying the extruded mixture using a dryer; and
vacuum-coating an additional fat into the dried, extruded mixture, thereby producing the feed product,
wherein the feed product includes about 25 to about 40 wt % fat of the feed product, and
wherein the feed product includes low fines.

2. The method of claim 1, wherein the initial percentage of fat is about 5 to about 13 wt % of the feed product.

3. The method of claim 1, wherein the feed product includes fat at up to about 33 wt % of the feed product.

4. The method of claim 1, wherein a moisture level of the dried feed prior to vacuum-coating is about 1 to about 4 wt %.

5. The method of claim 1, wherein the initial percentage of fat comprises endogenous fat or added fat.

6. The method of claim 1, wherein the additional fat comprises palm oil.

7. The method of claim 1, wherein the step of vacuum-coating comprises applying a vacuum and releasing the vacuum over a period of about 20 to about 40 seconds.

8. The method of claim 7, wherein the vacuum reaches about 200 to about 250 mbar.

9. The method of claim 1, wherein the mixture is free of added fat prior to the step of vacuum-coating the additional fat.

10. The method of claim 1, wherein an amount of steam is added to the extruder prior to extruding the feed, wherein the amount of steam is about 0.1 to about 6.0 wt % of the mixture.

11. The method of claim 1, further comprising cooling the vacuum-infused feed.

12. The method of claim 1, wherein the extruded feed is dried for about 1 to about 30 minutes at a temperature of about 200 to about 600° F.

13. A method of feeding a high-fat feed product to an equine animal, the method comprising:
obtaining a high-fat feed product, the product comprising about 25 to about 40 wt % fat, wherein the product includes a smooth, fat-coated exterior and with low fines;
combining the high-fat feed product with a base feed; and
feeding the high-fat feed product combined with the base feed to the equine animal, wherein, in response to the high-fat feed product having the smooth, fat-coated exterior and low fines, the equine animal increases consumption of the high-fat feed product.

14. The method of claim 13, wherein the step of feeding the high-fat feed product to the equine animal further comprises feeding forage to the animal.

15. The method of claim 13, wherein the equine animal improves performance in response to ingesting the high-fat feed product.

16. The method of claim 13, wherein the equine animal consumes about 1.5 to about 4.0 pounds of the high-fat feed product per day.

17. The method of claim 13, wherein the equine animal consumes about 3.0 to about 4.0 pounds of the high-fat feed product per day.

18. The method of claim 13, wherein the equine animal is a high performance equine animal.
